(19) United States
(12) Patent Application Publication
(10) Pub. No.: US 2021/0176843 A1
(43) Pub. Date: Jun. 10, 2021

(54) DYNAMIC LIGHT FIELD SYSTEM

(71) Applicant: AMERICAN FUTURE TECHNOLOGY, City of Industry, CA (US)

(72) Inventor: You-Chi LIU, City of Industry, CA (US)

(21) Appl. No.: 17/091,779

(22) Filed: Nov. 6, 2020

(30) Foreign Application Priority Data
Dec. 4, 2019 (TW) 108144368

(51) Int. Cl. H05B 47/155; H05B 47/16

(52) U.S. Cl. CPC H05B 47/155; H05B 47/16

(57) ABSTRACT

A dynamic light field system includes a controller having a processing module for outputting a color signal based on a selected preset dynamic light field, and the processing module includes a timing unit for generating a timing signal to control light emitting devices to create the dynamic light field, and a transmission module for transmitting the color signal and the timing signal. The light emitting devices can form a perception zone to provide the user located in the perception zone to feel the dynamic light field. Each light emitting device includes light sources to emit multi-colored light, and a transmission unit for receiving the color signal and the timing signal transmitted from the transmission module. The controller and the light emitting devices can create the dynamic light field to make a user located in the perception zone feel the dynamic light field, to improve immersive experience.

This application claims the priority benefit of Taiwan patent application number 108144368, filed on Dec. 4, 2019.

### BACKGROUND OF THE INVENTION

### 1. Field of the Invention

The present invention provides a dynamic light field system. More particularly, in the dynamic light field system of the present invention, a controller is used to control a plurality of light emitting devices to create and present a dynamic light field, so as to make a user located in a perception zone feel the dynamic light field, thereby achieving the effect of immersive experience.

### 2. Description of the Related Art

In recent years, the lighting system is more and more advanced; for example, the LED light has the advantages of adjustable dimming function, low power consumption, small size, not easy to break or damage, and long service life, so the LED lighting system is more and more popular. Since the lighting systems become advanced, flexible and more integrated for various applications, the lighting system can be applied in many fields such as gaming industry, retail industry, hotel industry or home field, etc. to enhance the experience, so as to improve productivity, safety, efficiency and leisure.

The conventional lighting system uses one or two lamp posts only to create a two-dimensional scene (such as a torch scene). However, people's sensory requirements are getting higher and higher, the two-dimensional scene formed by one or two lamp posts is not good enough to make people feel immersive experience, so people's desire to build a light system is greatly reduced, and the conventional lighting system is no longer competitive in the market.

### SUMMARY OF THE INVENTION

An objective of the present invention is that a controller includes a processing module which can output a color signal based on a selected preset dynamic light field, and the processing module includes a timing unit disposed therein and configured to generate a timing signal to control a plurality of light emitting devices to create the selected dynamic light field, and the controller includes a transmission module electrically connected to the processing module and configured to transmit the color signal and the timing signal. A perception zone can be formed among the plurality of light emitting devices to provide a user located the perception zone to feel the dynamic light field. Each of the plurality of light emitting devices includes a plurality of light sources configured to emit multi-colored light, and a transmission unit electrically connected to the plurality of light sources and configured to receive the color signal and the timing signal transmitted from the transmission module. Therefore, the controller and the plurality of light emitting devices can create the dynamic light field to make the user located in the perception zone feel the dynamic light field, thereby achieving the purpose of providing immersive experience.

Another objective of the present invention is that the plurality of light emitting devices include two front lights disposed on left and right sides in front of the perception zone, and two rear lights disposed on left and right sides behind the perception zone; a center light can further be disposed between the two front lights and configured to continue the lighting of the two front lights, so as to achieve the purpose of presenting the light field more smoothly.

Another objective of the present invention is that a light emitting pad and a top light can be disposed on and above the perception zone, the light emitting pad and the top light can be in cooperation with the two front lights and the two rear lights together to present the three-dimensional dynamic light field, so as to make the user located in the perception zone feel the dynamic light field in all directions, thereby achieving the purpose of improving immersive experience.

### BRIEF DESCRIPTION OF THE DRAWINGS

The structure, operating principle and effects of the present invention will be described in detail by way of various embodiments which are illustrated in the accompanying drawings.

FIG. 1 is a schematic diagram of an embodiment of a dynamic light field system of the present invention.

FIG. 2 is a block diagram of an embodiment of a dynamic light field system of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

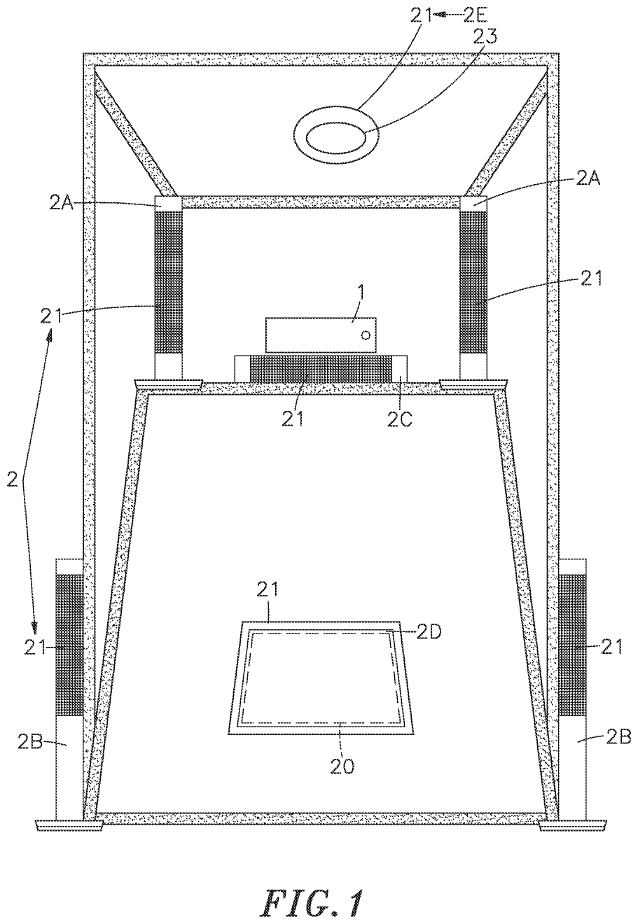

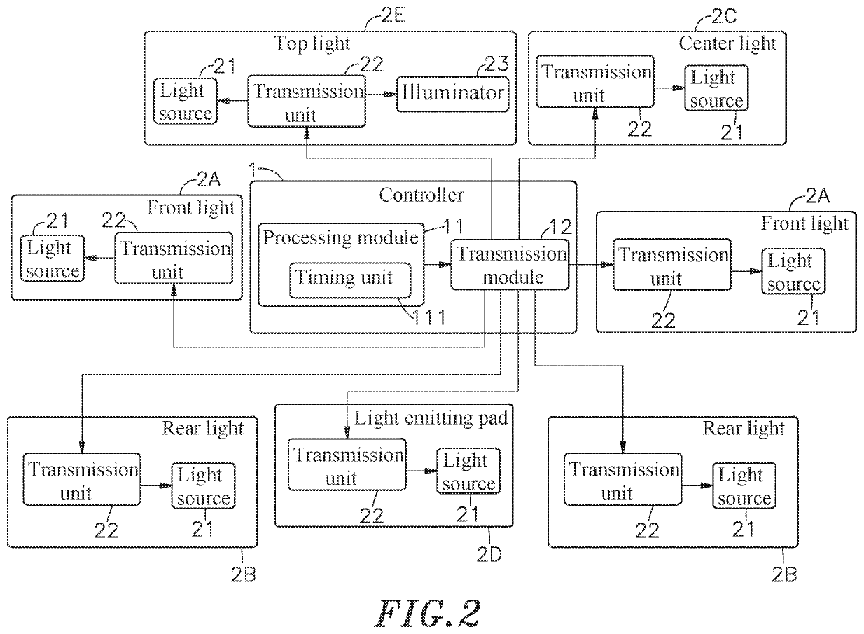

Please refer to FIGS. 1 and 2. As shown in FIGS. 1 and 2, a dynamic light field system of the present invention includes a controller 1 and a plurality of light emitting devices 2.

The controller 1 includes a processing module 11 configured to output a color signal based on a dynamic light field selected by a user, and the processing module 11 includes a timing unit 111 disposed therein and configured to generate a timing signal to control the plurality of light emitting devices 2 to create the dynamic light field. The controller 1 includes a transmission module 12 electrically connected to a side of the processing module 11.

The plurality of light emitting devices 2 includes two front lights 2A and two rear lights 2B configured to form a perception zone 20 therebetween to provide a user, who is located in the perception zone 20, to feel the dynamic light field. Each of the plurality of light emitting devices 2 includes a plurality of light sources 21 (such as light emitting diodes) arranged in array and configured to outwardly emit multi-colored light, and a transmission unit 22 electrically connected to a side of the plurality of light sources 21.

Each of the transmission module 12 of the controller 1 and the transmission unit 22 of the light emitting device 2 can be a wired transmission interface or a wireless transmission interface for signal transmission; for example, the wired transmission interface can be a wired. connection interface of USB or micro USB specification, and the wireless transmission interface can be a short-distance communication device such as a Bluetooth module or a WIFI module.

Furthermore, each of the front lights 2A and the rear lights 2B can include 90 light sources 21.

Preferably, the controller 1 and the plurality of light emitting devices 2 can be electrically connected to an external power supply through a power transmission line (not shown in FIG-S. 1 and 2), so as to supply power to the controller 1 and the plurality of light emitting devices 2 through the external power source. In an embodiment, the power transmission line can be a power plug, and the external power supply can be a commercial power socket or a power supply socket of a power generator; however, in actual application, the controller 1 and the plurality of light emitting devices 2 can be electrically connected to an external portable power storage device (such as a power bank) through a USB power transmission line. It should be noted that there are many known manners and structures to supply power to the controller 1 and the light emitting devices 2, but the details of known power supply manners and structures are not the key feature of the present invention, so detailed description is not repeated herein.

In practical use, the dynamic light field system of the present invention can be applied to a game room, a living room or a bedroom, etc.; the controller 1 can be disposed in the room, the two front lights 2A of the light emitting devices 2 can be disposed on the left and right sides of the front part of the room, and the two rear light 2B of the light emitting devices 2 can be disposed on the left and right sides of the rear part of the room, and the perception zone 20 is formed among the two front lights 2A and the two rear lights 2B. A user can stand or sit in a seat to be located in the perception zone 20, and use an electronic device (such as a smartphone, a tablet, a laptop or a desktop computer) to communicate with the transmission module 12 of the controller 1; for example, through the electronic device, the user can select the dynamic light field to be presented, such as a dynamic light field of breathing light, flame or sea. After the controller 1 receives the signal transmitted from the electronic device, the controller 1 can transmit the color signal and the timing signal to the transmission module 12 through the processing module 11 and the timing unit 111; the transmission module 12 of the controller 1 then transmits the color signal and the timing signal to the transmission units 22 of the light emitting devices 2, and the transmission unit 22 of each light emitting device 2 then transmits the color signal and the timing signal to the corresponding light sources 21, to enable the light sources 21 to emit light based on the received color signal and timing signal, so that the light sources 21 of the light emitting devices 2 can emit light in a continuous manner. Therefore, the controller 1 and the light emitting devices 2 can create the dynamic light field to make the user located in the perception zone 20 feel the dynamic light field, thereby achieving the effect of immersive experience.

In an embodiment, the above-mentioned electronic device can also transmit at least one image file to the processing module 11 of the controller 1, and the processing module 11 compares color pixels (such as RGB values) in the image file with an international color code table by a preset algorithm, to analyze and obtain the color signals of the international color codes corresponding to the color pixels in the image file, and the processing module 11 of the controller 1 then uses the timing unit 111 to add the color signals of the international color codes into the timing signal to be transmitted, and then transmits the color signals and the timing signal to the transmission module 12, so that the color signals and the timing signal can be transmitted to the transmission units 22 of the light emitting devices 2 through the transmission module 12. After the transmission units 22 of the light emitting devices 2 receive the color signals and the timing signal, each transmission unit 22 transmits the received color signals and the timing signal to the corresponding light sources 21, so that the light sources 21 of each light emitting device 2 can emit light based on the color signals and the timing signal, to display the corresponding colors based on the time slots scheduled by the timing signal. Compared with the conventional technology, the controller 1 and the light emitting devices 2 of the present invention can continuously create and present the dynamic light field based on at least one image file, so that the user is not limited to the dynamic light field built in the program of the electronic device, and the diversity of the light field in use can be improved. In the dynamic light field system of the present invention, the user can use the image file to create and present the dynamic light field, and the difficulty in producing the dynamic light field can be reduced, thereby achieving the effect of improving convenience in production and use.

Furthermore, the electronic device can be installed with a preset application or mobile application, so that the image file to be transmitted can be selected through the preset application or mobile application, and the time sequence of the timing signal generated by the timing unit 111 can be adjusted to change the lighting times of the plurality of light sources 21 of the plurality of light emitting devices 2. The time sequence is greater than zero second. The timing unit 111 of the processing module 11 can be controlled by the electronic device, so that the time sequence can be changed to adjust the display time of the dynamic light field by the electronic device, thereby improving variability in use and making the dynamic light field system of the present invention more competitive.

When the dynamic light field system of the present invention displays and presents the dynamic light field, each light emitting device 2 can display at least one image file individually and the light emitting devices 2 are in cooperation together to display and create the dynamic light field; however, in actual application, the plurality of light emitting devices 2 can display at least one image file together, that is, the plurality of light emitting devices 2 can continue to play at least one image file, so as to display and create the dynamic light field in a manner of continuing playing the same image file.

In an embodiment, the dynamic light field system of the present invention can include a center light 2C disposed between the two front lights 2A. The center light 2C includes a plurality of light sources 21 arranged in array and configured to outwardly emit multi-colored light, and a transmission unit 22 electrically connected on a side of the plurality of light sources 21. The transmission unit 22 of the center light 2C receives the color signals and the timing signal transmitted from the transmission module 12 of the controller 1, and the plurality of light sources 21 of the center light 2C can emit light based on the received color signals and timing signal. Since the center light 2C is disposed between the two front lights 2A, the lighting operation of the center light 2C can be used to continue between the lighting operations of the two front lights 2A, thereby making the display of the light field more smooth.

In an embodiment, the dynamic light field system can include a light emitting pad 2D and a top light 2E disposed on and above the perception zone 20 formed among the plurality of light emitting devices 2, respectively. Each of the light emitting pad 2D and the top light 2E includes a plurality of light sources 21 arranged in array and configured to outwardly emit multi-colored light. The plurality of light sources 21 of each of the light emitting pad 2D and the top light 2E are electrically connected to the corresponding transmission unit 22. The transmission units 22 of the light emitting pad 2D and the top light 2E can receive the color signal and the timing signal transmitted from the transmission module 12 of the controller 1, and the plurality of light sources 21 of the light emitting pad 2D and the top light 2E can emit light based on the received color signal and timing signal. Since the light emitting pad 2D and the top light 2E are disposed on and above the perception zone 20 respectively, the light emitting pad 2D and the top light 2E can be in cooperation with the two front lights 2A and the two rear lights 2B to display the three-dimensional dynamic light field together, to make the user located in the perception zone 20 feel the dynamic light field in all directions, thereby improving the user's immersive experience.

In an embodiment, the light emitting pad 2D can include 149 light sources 21, and the top light 2E can include 40 light sources 21 arranged in a circle. The light sources 21 of the top light 2E can include at least one illuminator 23 for emitting white light, for example, the top light 2E can include 13 illuminators 23 emitting white light outwardly for indoor illumination.

Preferably, the light sources 21 of the light emitting device 2 can emit light on a wall to present the dynamic light field by using the wall as a project screen; however, in actual application, the light sources 21 of the light emitting device 2 can directly emit light to the perception zone 20.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A dynamic light field system, comprising a controller and a plurality of light emitting devices, wherein the controller comprises a processing module configured to output a color signal based on a dynamic light field selected by a user, and the processing module comprises a timing unit disposed therein and configured to generate a timing signal to control the plurality of light emitting devices to create the dynamic light field, the controller comprises a transmission module electrically connected on a side of the processing module and configured to transmit the color signal and the timing signal;
wherein the plurality of light emitting devices form a perception zone to provide the user located in the perception zone to feel the dynamic light field, and each of the plurality of light emitting devices comprises a plurality of light sources configured to emit multi-colored light, and a transmission unit electrically connected to a side of the plurality of light sources and configured to receive the color signal and the timing signal transmitted from the transmission module, wherein the plurality of light emitting devices comprise two front lights disposed on left and right sides in front of the perception zone, and two rear lights disposed on left and right sides behind the perception zone.

2. The dynamic light field system according to claim 1, wherein each of the two front lights and the two rear lights comprises 90 light sources.

3. The dynamic light field system according to claim 1, further comprising a center light disposed between the two front lights, wherein the center light comprises a plurality of light sources configured to emit multi-colored light, and a transmission unit electrically connected to a side of the plurality of light sources and configured to receive the color signal and the timing signal transmitted from the transmission module.

4. The dynamic light field system according to claim 1, further comprising a light emitting pad and a top light disposed in and above the perception zone, respectively, wherein each of the light emitting pad and the top light comprises a plurality of light sources configured to emit multi-colored light to make the user located in the perception zone feel a three-dimensional dynamic light field, and a transmission unit electrically connected to a side of the plurality of light sources and configured to receive the color signal and the timing signal transmitted from the transmission module.

5. The dynamic light field system according to claim 4, wherein the light emitting pad comprises 149 light sources, and the top light comprises 40 light sources arranged in a circle.

6. The dynamic light field system according to claim 4, wherein the plurality of light sources of the top light comprise a plurality of illuminators emitting white light.

7. The dynamic light field system according to claim 6, wherein the top light comprises 13 illuminators.
